(19) United States
(12) Patent Application Publication
(10) Pub. No.: US 2009/0327309 A1
(43) Pub. Date: Dec. 31, 2009

(54) METHOD FOR PROTECTING FILES OF DIGITAL PHOTO FRAME

(75) Inventors: JIAN-FENG GUO, Shenzhen City (CN); ZHEN-MIN SONG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (CN); HON HAI PRECISION INDUSTRY CO., LTD., Tu Cheng (TW)

(21) Appl. No.: 12/406,179

(22) Filed: Mar. 18, 2009

(30) Foreign Application Priority Data
Jun. 27, 2008 (CN) 200810302413.X

(51) Int. Cl. G06F 12/16; G06F 17/30

(52) U.S. Cl. 707/10; 707/204; 707/E17.019; 707/E17.101; 707/E17.044; 707/E17.01

(57) ABSTRACT

A method for protecting files of a digital photo frame includes an applying module of the digital photo frame detecting whether there are files in a storage system, which is accessed by the digital photo frame. If not, the applying module copies the files of the storage module to the storage system. If yes, the applying module judges whether the files of the storage module are the same as the files of the storage system. If not, the applying module copies the files of the storage module to the storage system.

### BACKGROUND

1. Technical Field

The present disclosure relates to methods for protecting files, and particularly to a method protecting files of a digital photo frame from careless deletion.

2. Description of the Related Art

A typical digital photo frame uses a storage card to store documents and digital image files. Since the storage card has limited space, files stored in the storage card may be deleted to store new files. Therefore, the files of the storage card may be carelessly deleted before backup.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is a block diagram of a digital photo frame, a network connection, and a storage system utilizing an embodiment of a method to copy files of the digital photo frame to the storage system.

FIG. 2 is a flow chart illustrating an embodiment of the method for coping files of the digital photo frame of FIG. 1 to the storage system.

### DETAILED DESCRIPTION OF THE EMBODIMENTS

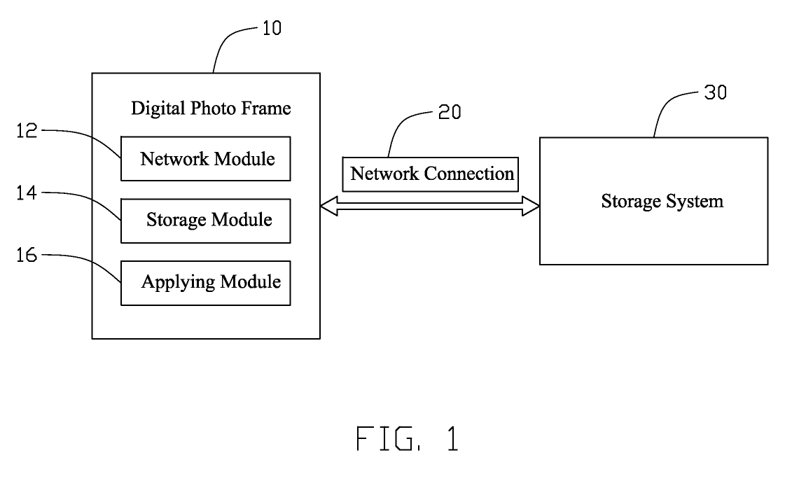

FIG. 1 is a digital photo frame 10, a network connection 20, and a storage system 30 utilizing an embodiment of a method to copy files of the digital photo frame 10 to the storage system 30 via the network connection 20, thereby protecting the files of the digital photo frame 10 from careless deletion. The storage system 30 may be a computer, a server, or other electronic devices, and has at least one folder for storing files.

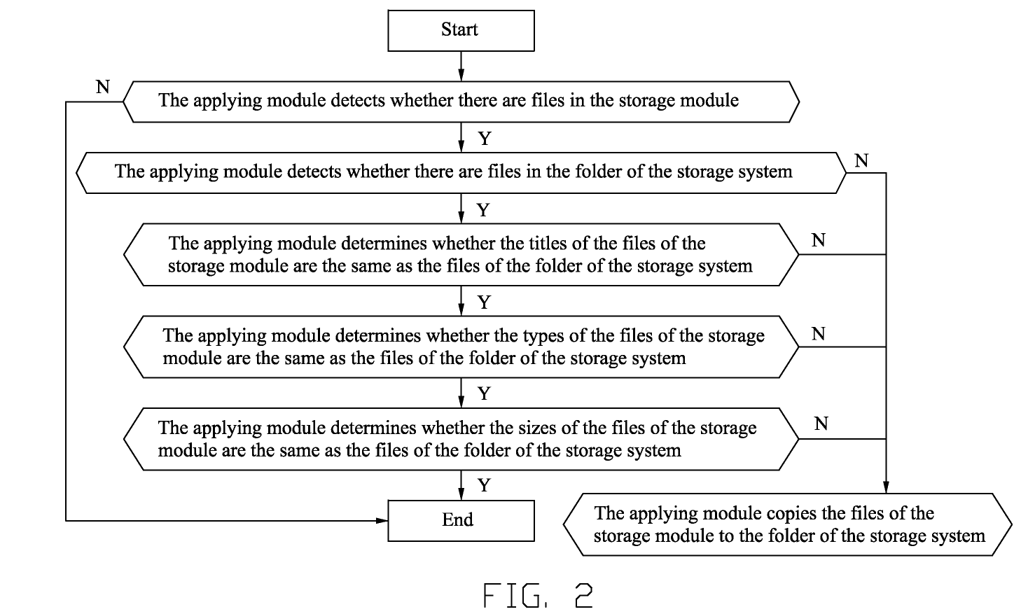

The digital photo frame 10 includes a network module 12, a storage module 14, and an applying module 16. The network module 12 may be a network card, or other electronic devices capable of connecting the digital photo frame 10 to the network. The storage module 14 may be a storage card, and is capable of storing files. The applying module 16 is capable of automatically detecting whether there are files stored in the storage module 14 and the folder of the storage system 30, before copying the files of the storage module 14 to the storage system 30, determining whether the files of the storage system 30 are the same as the files in the folder of the storage module 14 when the files of the storage module 14 and the storage system 30 are identified, and copying files from the storage module 14 to the folder of the storage system 30 when the files of the storage module 14 are different from the files of the storage system 30. Furthermore, in determining whether the files of the storage system 30 are the same as the files in the folder of the storage module 14, the applying module 16 detects and checks the titles, types, and sizes of the files in the storage module 14 to determine whether the same files exist in the storage system 30 (as shown in FIG. 2).

Referring also to FIG. 2, a method for copying the files of the storage module 14 to the storage system 30 is shown. Depending on the embodiment, certain of the steps described below may be removed, others may be added, and the sequence of steps may be altered.

The applying module 16 detects whether there are files in the storage module 14 of the digital photo frame 10. If no files are detected, the applying module 16 does not copy any file to the storage system 30. If files are detected, the applying module 16 detects whether there are files stored in the folder of the storage system 30. If no files are stored in the folder of the storage system 30, the applying module 16 copies the files of the storage module 14 to the folder of the storage system 30. If there are files stored in the folder of the storage system 30, the applying module 16 determines whether the titles of the files in the storage module 14 are the same as the files in the storage system 30. If the titles of the files are not the same as the files in the storage system 30, the applying module 16 copies the files of the storage module 14 to the folder of the storage system 30. If the titles of the files are the same as the files in the storage system 30, the applying module 16 determines whether the types of the files in the storage module 14 are the same as the files in the storage system 30. If the types of the files are not the same as the files in the storage system 30, the applying module 16 copies the files in the storage module 14 to the folder of the storage system 30. If the types of the files are the same as the files in the storage system 30, the applying module 16 determines whether the sizes of the files in the storage module 14 are the same as the files in the storage system 30. If the files in the storage module 14 and the storage system 30 are not the same size, the applying module 16 copies the files in the storage module 14 to the folder of the storage system 30. If the files in the storage module 14 and the storage system 30 are the same size, the applying module 16 does not copy any file from the storage module 14 to the storage system 30.

In the embodiment, the files of the storage module 14 of the digital photo frame and the folder of the storage system 30 may be digital image files, audio files, or video files.

It is to be understood, however, that even though numerous characteristics and advantages have been set forth in the present disclosure, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for protecting files of a digital photo frame, comprising:
an applying module of the digital photo frame detecting whether there are files in a storage system, which is accessed by the digital photo frame;
if there are no files in the storage system, the applying module copying the files of the storage module to the storage system;
if there are files in the storage system, the applying module determining whether the files of the storage module are the same as the files of the storage system;
if the files of the storage module are different from the files of the storage system, the applying module copying the files of the storage module to the storage system.

2. The method of claim 1, wherein the digital photo is capable of accessing the storage system via a network connection.

3. The method of claim 2, wherein a network module is formed in the digital photo frame for connecting the digital photo frame with the storage system via the network connection.

4. The method of claim 1, wherein the step that the applying module determining whether the files of the storage module are the same as the files of the storage system comprises at least one of the following steps:
the applying module determining whether the titles of the files of the storage module are the same as the files of the storage system;
the applying module determining whether the types of the files of the storage module are the same as the files of the storage system;
the applying module determining whether the sizes of the files of the storage module are the same as the files of the storage system.

5. The method of claim 1, wherein a folder is defined by the storage system for storing the files of the storage module.

6. The method of claim 1, wherein the files of the storage module and the storage system are at least one of the following: digital image files, audio files, and video files.

7. The method of claim 1, wherein the storage module is a storage card.
